(19) United States
(12) Patent Application Publication
(10) Pub. No.: US 2023/0224330 A1
(43) Pub. Date: Jul. 13, 2023

(54) MALICIOUS DNS SERVER DETECTION DEVICE AND CONTROL METHOD THEREOF

(71) Applicant: AI SPERA INC., Seoul (KR)

(72) Inventors: Byungtak KANG, Seoul (KR); Hwajae CHOI, Seoul (KR)

(73) Assignee: AI SPERA INC., Seoul (KR)

(21) Appl. No.: 18/180,930

(22) Filed: Mar. 9, 2023

Related U.S. Application Data
(63) Continuation of application No. PCT/KR2020/015672, filed on Nov. 10, 2020.

(30) Foreign Application Priority Data
Oct. 19, 2020 (KR) 10-2020-0134882

(51) Int. Cl. H04L 9/40

(52) U.S. Cl. CPC H04L 63/1483; H04L 63/1416; H04L 63/1425

(57) ABSTRACT

Disclosed is a malicious domain name system (DNS) server detecting method performed by a server detection device including transmitting at least one domain address thus pre-verified to at least one DNS server candidate, receiving at least one IP address associated with the transmitted at least one domain address from the at least one DNS server candidate, determining at least one verification target DNS server based on the received at least one IP address, and determining a malicious DNS server among the at least one verification target DNS server by comparing at least one normal IP address with the received at least one IP address.

### CROSS-REFERENCE TO RELATED APPLICATIONS

The present application is a continuation of International Patent Application No. PCT/KR2020/015672, filed on Nov. 10, 2020, which is based upon and claims the benefit of priority to Korean Patent Application No. 10-2020-0134882 filed on Oct. 19, 2020. The disclosures of the above-listed applications are hereby incorporated by reference herein in their entirety.

### BACKGROUND

Embodiments of the inventive concept described herein relate to a malicious domain name system (DNS) server detection device and a control method thereof, and more particularly, relate to a malicious DNS server detection device for detecting a malicious DNS server based on a domain address and an IP address, and a control method thereof.

With the convenience of Internet, the Internet is being used in all areas of daily life, for example, an electronic payment, corporate advertisement through a web server or e-commerce in addition to handling simple tasks such as e-mail and file transfer in economic activities of individuals and businesses. As such, as the Internet is generally used, malicious DNS servers are rapidly increasing on the Internet. A normal IP address is illegally changed to a harmful IP address by the malicious DNS servers.

### SUMMARY

Embodiments of the inventive concept provide a malicious DNS server detection device that prevents damages from illegally changing a normal IP address to a harmful IP address by detecting malicious DNS servers in advance and providing the detected result to Internet users, and a control method thereof.

According to an embodiment, a malicious domain name system (DNS) server detecting method performed by a server detection device includes transmitting at least one domain address thus pre-verified to at least one DNS server candidate, receiving at least one IP address associated with the transmitted at least one domain address from the at least one DNS server candidate, determining at least one verification target DNS server based on the received at least one IP address, and determining a malicious DNS server among the at least one verification target DNS server by comparing at least one normal IP address with the received at least one IP address.

According to an embodiment of the present disclosure, the at least one DNS server candidate may be selected periodically by using a port scan, and a use service port is at least one of user datagram protocol (UDP) 53 and transmission control protocol (TCP) 53.

According to an embodiment of the present disclosure, the determining of the at least one verification target DNS server may include determining only a DNS server candidate, which receives an IP address, among the at least one DNS server candidate as the verification target DNS server.

According to an embodiment of the present disclosure, the determining of the malicious DNS server may include determining at least one DNS server, which is associated with at least one IP address that is not the same as the at least one normal IP address, from among the received at least one IP address as the malicious DNS server. The at least one normal IP address may be periodically obtained from at least one DNS server thus pre-verified by transmitting the pre-verified at least one domain address to the pre-verified at least one DNS server.

According to an embodiment, a malicious DNS server detection device includes a communication unit, a memory, and a processor that allows the communication unit to transmit at least one domain address thus pre-verified to at least one DNS server candidate, allows the memory to store at least one normal IP address, receives at least one IP address associated with the transmitted at least one domain address from the at least one DNS server candidate through the communication unit, determines at least one verification target DNS server based on the received at least one IP address, and determines a malicious DNS server among the at least one verification target DNS server by comparing at least one normal IP address with the received at least one IP address.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram for detecting a malicious DNS server, according to an embodiment of the inventive concept;

FIG. 2 is a block diagram showing a malicious DNS server detection device, according to an embodiment of the inventive concept;

FIG. 3 is a flowchart illustrating a method for detecting a malicious DNS server, according to an embodiment of the inventive concept;

FIG. 4 is a flowchart illustrating a method for detecting a malicious DNS server, according to an embodiment of the inventive concept; and

FIG. 5 is a flowchart illustrating a method for detecting a malicious DNS server, according to an embodiment of the inventive concept.

### DETAILED DESCRIPTION

The above and other aspects, features and advantages of the inventive concept will become apparent from embodiments to be described in detail in conjunction with the accompanying drawings. The inventive concept, however, may be embodied in various different forms, and should not be construed as being limited only to the illustrated embodiments. Rather, these embodiments are provided as examples so that the inventive concept will be thorough and complete, and will fully convey the scope of the inventive concept to those skilled in the art. The inventive concept may be defined by the scope of the claims.

The terms used herein are provided to describe embodiments, not intended to limit the inventive concept. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the inventive concept.

A word “exemplary” is used herein in the sense of “being used as an example or illustration”. An embodiment described herein as “exemplary” is not necessarily to be construed as preferred or advantageous over other embodiments.

The term “unit” used herein may refer to software or hardware such as field programmable gate array (FPGA) or application specific integrated circuit (ASIC), and the “unit” may perform some functions. However, the “unit” may be not limited to software or hardware. The “unit” may be configured to exist in an addressable storage medium or may be configured to play one or more processors. Therefore, as an example, “units” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” and elements may be combined into a smaller number of “units” and elements or may be divided into additional “units” and elements.

Moreover, in this specification, all “units” may be controlled by at least one processor, and at least one processor may perform operations performed by the “units” of the inventive concept.

Embodiments of the inventive concept may be described in terms of a function or a block performing a function. A block capable of being referred to as a ‘unit’ or a ‘module’ of the inventive concept is physically implemented by analog or digital circuits such as logic gates, integrated circuits, microprocessors, microcontrollers, memories, passive electronic components, active electronic components, optical components, hardwired circuits, and the like and may be selectively driven by firmware and software.

Embodiments of the inventive concept may be implemented by using at least one software program running on at least one hardware device and may perform a network management function of controlling an element.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

According to an embodiment of the inventive concept, a normal IP address refers to an IP address received from a DNS server that is previously verified. The normal IP address may be a correct IP address corresponding to a specific domain address. Moreover, the normal IP address may be in a form of listing one or more IP addresses.

In the inventive concept, the pre-verified domain address may be transmitted to receive an IP address from a DNS server candidate, and may be a domain address that is generally well known to users. For example, the pre-verified domain address may be “www.naver.com”, “www.google.com”, and the like.

In the inventive concept, the pre-verified DNS server may include a DNS server of a company operating a website corresponding to the pre-verified domain address.

In the inventive concept, in determining whether a verification target DNS server is a malicious DNS server, the verification target DNS server may be determined as a malicious or normal DNS server depending on the returned IP address. Furthermore, the verification target DNS server may refer to all DNS servers except for the pre-verified DNS server.

In the inventive concept, the malicious DNS server may be a server that returns an IP address different from the IP address returned by the pre-verified DNS server.

Hereinafter, an embodiment of the inventive concept will be described in detail with reference to the accompanying drawings.

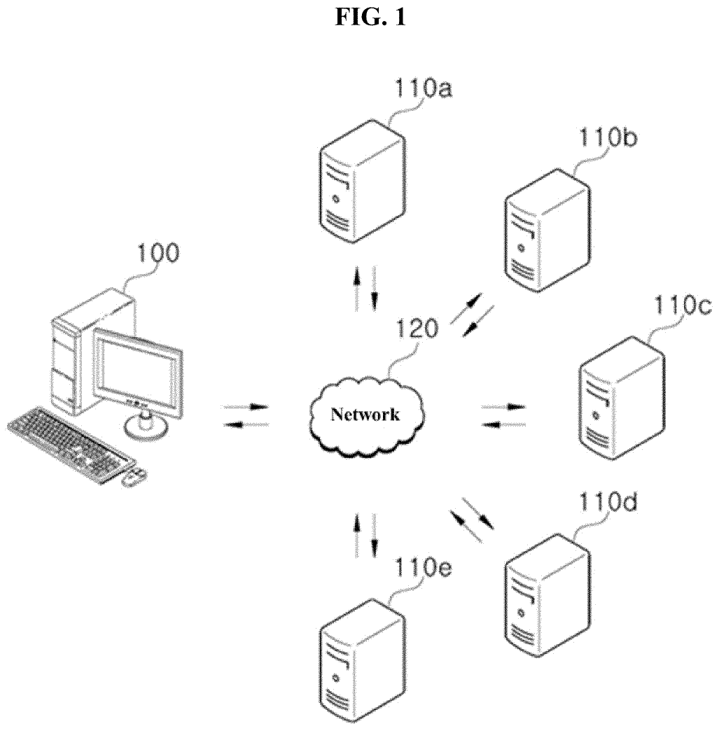

FIG. 1 is a schematic diagram for detecting a malicious DNS server, according to an embodiment of the inventive concept.

A malicious DNS server detection device 100 may communicate with at least one server 110a, 110b, 110c, 110d, or 110e to detect a malicious DNS server. In this case, the malicious DNS server detection device 100 may communicate with the at least one server 110a, 110b, 110c, 110d, or 110e by using a network 120. The network 120 may include a connection unit (not shown) such as a wired or wireless communication link or an optical fiber cable. Alternatively, the network 120 may also be implemented as various networks such as Intranet, a local area network (LAN), or a wide area network (WAN).

Referring to FIG. 1, the malicious DNS server detection device 100 and the at least one server 110a, 110b, 110c, 110d, or 110e connect to the network 120. In the example shown, the server 110a, 110b, 110c, 110d, or 110e may provide data such as boot files, operating system images or applications, and IP addresses to the malicious DNS server detection device 100.

When a general user of an electronic device (not shown) accesses the malicious DNS server, the malicious DNS server returns an IP address of a fake site instead of a normal IP address when the domain address is entered into an Internet browser. In this case, the DNS refers to a system that converts a domain name into an IP address to access a specific site with only a domain name without having to memorize the numbered IP address. For example, an IP address is a 4-byte numeric address identified by a period for each byte, such as “111.112.113.114”. On the other hand, a domain name is composed of characters such as “www.abc.co.kr”, and thus it is easier to understand or remember a domain name than numbers.

Furthermore, the at least one server 110a, 110b, 110c, 110d, or 110e of FIG. 1 may be connected to the network 120 by using a port.

The port is an endpoint of a logical connection between a user's electronic device (not shown) connected through the network 120 and the server 110a, 110b, 110c, 110d, or 110e. Ports are usually identified by port numbers. The port numbers range from 0 to 65,536. The port numbers are assigned by Internet Assigned Numbers Authority (IANA). The IANA is administered by the International Internet Corporation for Assigned Names and Numbers (ICANN).

The server 110a, 110b, 110c, 110d, or 110e has a port being used and a port not being used. Some port numbers are assigned in advance depending on the type of an application or service associated with a current server. These pre-assigned or standard port numbers are referred to as well-known ports. The number of well-known port numbers assigned or pre-assigned to specific services and applications is approximately 1,024. For example, the well-known port numbers include port 80 for hypertext transfer protocol (HTTP) traffic, port 23 for telnet, port 25 for simple mail transfer protocol (SMTP), port 53 for domain name server (DNS), and port 194 for Internet relay chat (IRC), but not limited thereto. Accordingly, any port on any server assigned for HTTP may typically have an assigned port number of 80.

Referring to FIG. 1, the malicious DNS server detection device 100 may select a DNS server candidate among the at least one server 110a, 110b, 110c, 110d, or 110e, may transmit a pre-verified domain address to the selected DNS server candidate, and may determine a malicious DNS server based on the received IP address.

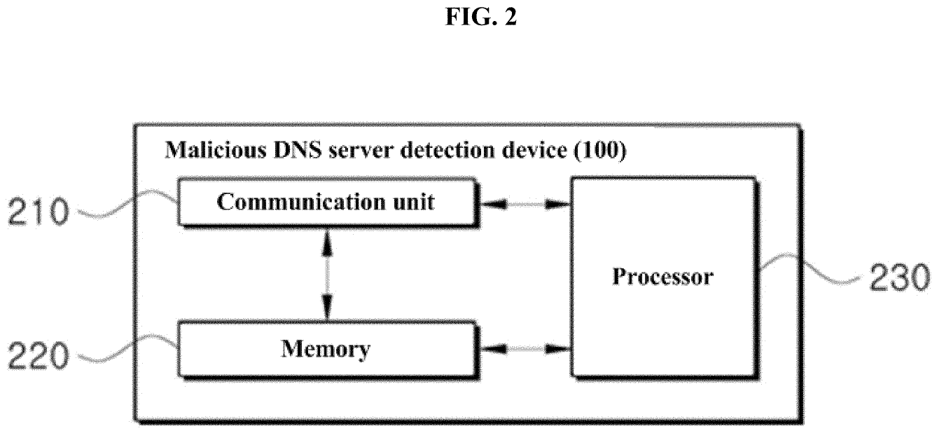

A method of determining a malicious DNS server will be described later in detail with reference to FIGS. 2 to 5.

FIG. 2 is a block diagram showing the malicious DNS server detection device 100, according to an embodiment of the inventive concept.

According to an embodiment of the inventive concept, the malicious DNS server detection device 100 may include a communication unit 210, a memory 220 and a processor 230.

According to an embodiment of the inventive concept, the malicious DNS server detection device 100 may include a server, mobile terminal, PDA, a smart phone, a desktop, and the like.

According to an embodiment of the inventive concept, the communication unit 210 may transmit a pre-verified domain address to the at least one server 110a, 110b, 110c, 110d, or 110e, and may receive an IP address as a return value from the at least one server 110a, 110b, 110c, 110d, or 110e.

Moreover, according to an embodiment of the inventive concept, the communication unit 210 may communicate with various types of external devices depending on various types of communication methods. The communication unit 210 may include at least one of a Wi-Fi chip, a Bluetooth chip, a wireless communication chip, and an NFC chip.

The Wi-Fi chip and the Bluetooth chip may perform communication using a WiFi method and a Bluetooth method, respectively. When a Wi-Fi chip or a Bluetooth chip is used, various pieces of connection information such as an SSID and a session key may be first transmitted and received, and various types of information may be transmitted and received after communication is connected using the Wi-Fi chip or the Bluetooth chip. The wireless communication chip refers to a chip that performs communication according to various communication standards such as IEEE, Zigbee, 3rd Generation (3G), 3rd Generation Partnership IP Project (3GPP), and Long Term Evolution (LTE). The NFC chip refers to a chip that operates in a near field communication (NFC) method by using a 13.56 MHz band among various RF-ID frequency bands such as 135 kHz, 13.56 MHz, 433 MHz, 860 to 960 MHz, and 2.45 GHz.

The memory 220 according to an embodiment of the inventive concept is a local storage medium capable of storing a pre-verified domain address, a pre-verified IP address, an IP address received by the communication unit 210, and data processed by the processor 230. As necessary, the communication unit 210 and the processor 230 may use data stored in the memory 220. Also, the memory 220 according to an embodiment of the inventive concept may store instructions used for the processor 230 to operate.

Moreover, even when the malicious DNS server detection device 100 is cut off, data needs to be stored. Accordingly, the memory 220 according to an embodiment of the inventive concept may be provided as a writable non-volatile memory (writable ROM) to reflect changes. That is, the memory 220 may be provided as one of a flash memory, an EPROM, or an EEPROM. For convenience of description in an embodiment of the inventive concept, it is described that all instruction information is stored in the single memory 220. However, an embodiment is not limited thereto. For example, the malicious DNS server detection device 100 may include a plurality of memories.

According to an embodiment of the inventive concept, the processor 230 may control the communication unit 210 such that at least one domain address thus pre-verified is transmitted to at least one DNS server candidate, and may receive at least one IP address related to at least one domain address transmitted from the at least one DNS server candidate through the communication unit 210.

Moreover, the processor 230 may control the memory 220 to store the pre-verified at least one domain address and at least one normal IP address.

Furthermore, according to an embodiment of the inventive concept, the processor 230 may determine at least one verification target DNS server based on the received at least one IP address, may compare the at least one normal IP address with the received at least one IP address, and may determine a malicious DNS server.

In the inventive concept, the pre-verified domain address may be transmitted to receive an IP address from a DNS server candidate, and may be a domain address that is generally well known to users. For example, the pre-verified domain address may be “www.naver.com”, “www.google.com”, and the like.

According to an embodiment of the inventive concept, the pre-verified at least one domain address may be stored in the memory 220. The pre-verified domain address stored in the memory 220 may be transmitted to a DNS candidate to determine at least one DNS server.

The pre-verified domain address may include well-known domain addresses, and may include the mean of domain reputations and the standard deviation of domain reputations. Furthermore, the pre-verified domain address may be obtained by using an external service provided by measuring the reputation ranking of a domain based on usage records of a domain The external service may be provided by an external server, and the external server (e.g., Alexa (registered trademark) server) may provide traffic volume or ranking information for each Internet site within a specific period. Accordingly, the processor 230 may obtain at least one domain address thus pre-verified from an external server through the communication unit 210 and may store the at least one domain address in the memory 220.

According to an embodiment of the inventive concept, the pre-verified DNS server may be a DNS server of a company operating a website corresponding to the pre-verified domain address. Moreover, the pre-verified DNS server may include a server that normally transmits a domain address to receive an IP address. For example, the pre-verified DNS server may include Google DNS server, Cloudflare DNS server, Open DNS server, comodo Secure DNS server, Quad9 DNS server, KT DNS server, SK DNS server, LG DNS server, and the like.

According to an embodiment of the inventive concept, the processor 230 may receive an IP address returned by transmitting the pre-verified domain address to at least one pre-verified DNS server. In this case, when a domain address is transmitted to a plurality of pre-verified DNS servers, an IP address returned for geographical reasons may be different for each of the plurality of pre-verified DNS servers. Accordingly, the processor 230 may list all IP addresses returned for specific domain addresses and may store the listed result in the memory 220. Here, there may be pre-verified domain addresses transmitted to the pre-verified DNS server.

Furthermore, according to an embodiment of the inventive concept, there may be one or more IP addresses associated with one domain address. Accordingly, a pre-verified DNS server that has received at least one domain address may return IP addresses, of which the number is equal to or greater than the number of received domain addresses, as return values.

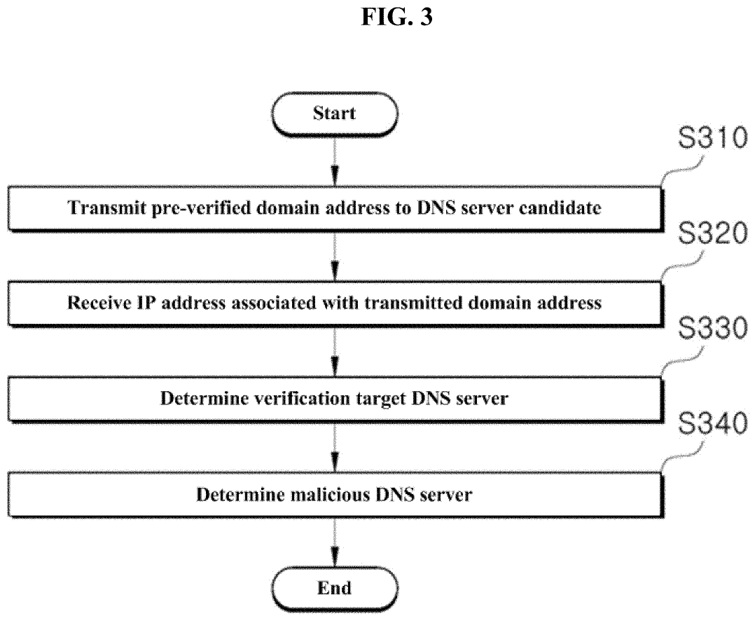

FIG. 3 is a flowchart illustrating a method for detecting a malicious DNS server, according to an embodiment of the inventive concept.

Each of steps of a control method of the malicious DNS server detection device 100 according to an embodiment of the inventive concept may be performed by various types of electronic devices including the communication unit 210, the memory 220, and the processor 230.

Hereinafter, a process for the processor 230 to detect a malicious DNS server according to an embodiment of the inventive concept will be mainly described in detail with reference to FIG. 3.

All or at least part of embodiments described for the malicious DNS server detection device 100 may be applied to the control method of the malicious DNS server detection device 100. On the other hand, all or at least part of embodiments described for the control method of the malicious DNS server detection device 100 may be applied to embodiments of the malicious DNS server detection device 100. Moreover, the control method of the malicious DNS server detection device 100 according to the disclosed embodiments is performed by the malicious DNS server detection device 100 disclosed herein, and the embodiment is not limited thereto. For example, the control method may be performed by various types of electronic devices.

First of all, the processor 230 of the malicious DNS server detection device 100 may transmit at least one domain address thus pre-verified to at least one DNS server candidate through the communication unit 210 [S310].

According to an embodiment of the inventive concept, at least one DNS server candidate may be selected periodically by using a port scan.

In the inventive concept, as a process of determining which port of the running server is opened, the port scan may transmit a request signal to a specific port already known to a server, and may determine whether the corresponding specific port is open, based on whether a response signal is received from the server. In this case, the DNS server generally uses a service port, which are user datagram protocol (UDP) 53 and transmission control protocol (TCP) 53. Accordingly, the processor 230 may select a server, whose usage service port is at least one of UDP 53 and TCP 53, from among the at least one server 110a, 110b, 110c, 110d, or 110e as a DNS server candidate.

In this specification, it has been described that a server whose usage service port is at least one of UDP 53 and TCP 53 is selected as a DNS server candidate, but is not necessarily limited thereto. Accordingly, the processor 230 may select a server using a specific port number among 0 to 65,536 port numbers as a DNS server candidate.

The port scan process itself corresponds to a known technology, and thus a detailed description thereof will be omitted to avoid redundancy.

According to an embodiment of the inventive concept, the at least one DNS server candidate may be periodically selected separately from detecting a malicious DNS server. For example, the processor 230 may select at least one DNS server candidate on a daily, weekly, or monthly basis. Moreover, whenever an external server providing a pre-verified domain address updates ranking information of domain addresses, the processor 230 may select the at least one DNS server candidate.

The processor 230 may transmit at least one domain address thus pre-verified to the selected at least one DNS server candidate.

Next, the processor 230 may receive at least one IP address associated with the transmitted at least one domain address from the at least one DNS server candidate through the communication unit 210 [S320].

According to an embodiment of the inventive concept, there may be one or more IP addresses associated with one domain address. Accordingly, the DNS server candidate that has received at least one domain address may return IP addresses, of which the number is equal to or greater than the number of received domain addresses, as return values.

Next, the processor 230 may determine at least one verification target DNS server based on the received at least one IP address [S330].

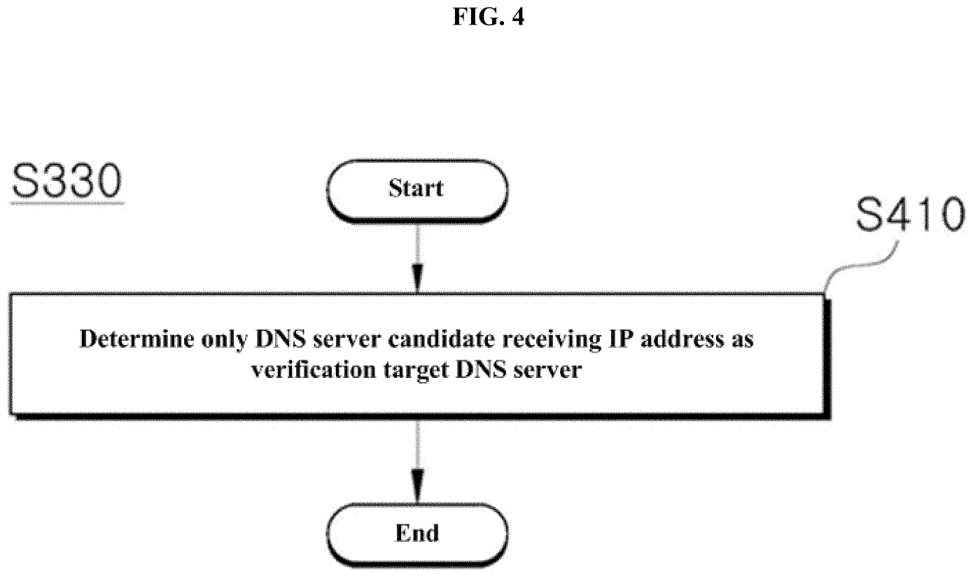

In the inventive concept, in determining whether the verification target DNS server is a malicious DNS server, the verification target DNS server may be determined by the processor 230. A method of determining a verification target DNS server will be described later in detail with reference to FIG. 4.

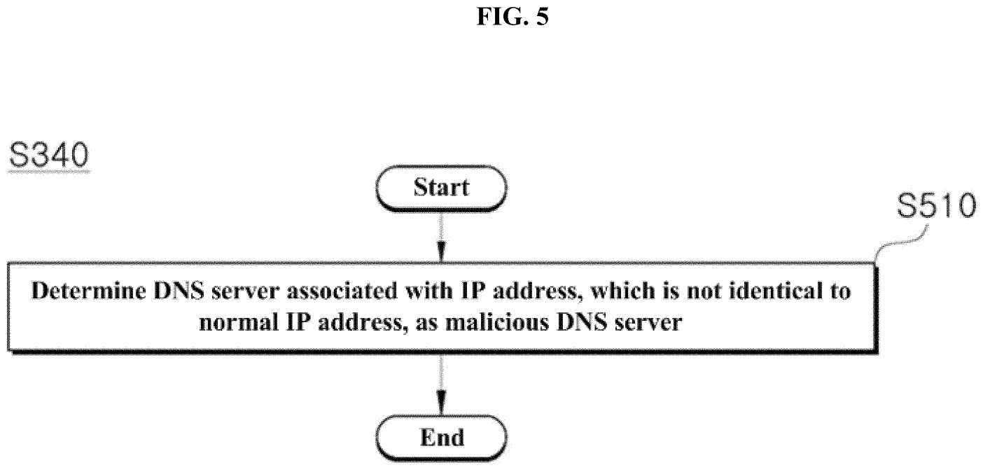

Next, the processor 230 may compare at least one normal IP address with the received at least one IP address and may determine a malicious DNS server among the at least one verification target DNS servers [S340]. A method of determining a malicious DNS server will be described later in detail with reference to FIG. 5.

FIG. 4 is a flowchart illustrating a method for detecting a malicious DNS server, according to an embodiment of the inventive concept. The step of FIG. 4 may be an example of S330 of FIG. 3.

According to an embodiment of the inventive concept, after receiving at least one IP address, the processor 230 may determine only a DNS server candidate which receives an IP address, from among the at least one DNS server candidate as a verification target DNS server [S410].

When a specific server is not a DNS server, the specific server may return data such as boot files, operating system images, or applications that are not related to IP addresses. Accordingly, the processor 230 may determine that only a DNS server candidate that returns at least one IP address as a return value is a verification target DNS server for determining whether the verification target DNS server is a malicious DNS server.

FIG. 5 is a flowchart illustrating a method for detecting a malicious DNS server, according to an embodiment of the inventive concept. The step of FIG. 5 may be an example of S340 of FIG. 3.

According to an embodiment of the inventive concept, after determining the verification target DNS, the processor 230 may determine at least one DNS server associated with at least one IP address, which is not the same as at least one normal IP address, from among at least one IP address thus received, as a malicious DNS server [S510].

In the inventive concept, a normal IP address may refer to an IP address received from a pre-verified DNS server. Accordingly, the normal IP address may be a correct IP address corresponding to a specific domain address. For example, the normal IP address may be an IP address corresponding to a specific domain or pre-verified domain address received from a DNS server operated by NAVER (registered trademark) and Google (registered trademark). Accordingly, when the verification target DNS server is a malicious DNS server, at least one IP address different from the normal IP may be returned as a return value for the transmitted at least one domain address.

According to an embodiment of the inventive concept, at least one normal IP address for a specific domain address received from at least one pre-verified DNS server may be listed by the processor 230 and may be stored in the memory 220.

Because at least one normal IP address for the specific domain address is listed, the processor 230 may compare the received at least one IP address with the at least one normal IP address. When the received at least one IP address includes at least one IP address that is not the same as the normal IP address, the processor 230 may determine the verification target DNS server, which has returned the corresponding IP address, as a malicious DNS server.

Besides, there may be a plurality of pre-verified domain addresses, and thus the verification target DNS server may return IP addresses for the plurality of domain addresses. In this case, when the returned IP addresses include at least one IP address that is not the same as the normal IP address, the processor 230 may determine the corresponding verification target DNS server as a malicious DNS server.

According to an embodiment of the inventive concept, the at least one normal IP address may be periodically obtained from the pre-verified at least one DNS server by transmitting the pre-verified at least one domain address to the pre-verified at least one DNS server. The obtained at least one normal IP address may be stored in the memory 220. Whenever at least one normal IP address is obtained, the memory 220 may update the stored IP address.

According to an embodiment of the inventive concept, the processor 230 may compare the IP address received from the verification target DNS server with the normal IP address. Only when both are the same as each other, the processor 230 may determine the corresponding verification target DNS server as a normal DNS server.

Various embodiments according to an embodiment of the inventive concept may be implemented as software including one or more instructions stored in a storage medium (e.g., a memory) readable by a machine (e.g., the malicious DNS server detection device 100 or a computer). For example, a processor (e.g., the processor 230) of the machine may call at least one instruction among the stored one or more instructions from a storage medium and then may execute the at least one instruction. This enables the machine to operate to perform at least one function depending on the called at least one instruction. The one or more instructions may include a code generated by a complier or a code executable by an interpreter. The machine-readable storage medium may be provided in the form of a non-transitory storage medium. Herein, ‘non-transitory’ just means that the storage medium is a tangible device and does not include a signal (e.g., electromagnetic waves), and this term does not distinguish between the case where data is semipermanently stored in the storage medium and the case where the data is stored temporarily. For example, the ‘non-transitory storage medium’ may include a buffer in which data is temporarily stored.

According to an embodiment, a method according to various embodiments disclosed in the specification may be provided to be included in a computer program product. The computer program product may be traded between a seller and a buyer as a product. The computer program product may be distributed in the form of a machine-readable storage medium (e.g., compact disc read only memory (CD-ROM)) or may be distributed (e.g., downloaded or uploaded), through an application store (e.g., PlayStore™), directly between two user devices (e.g., smartphones), or online. In the case of on-line distribution, at least part of the computer program product (e.g., a downloadable app) may be at least temporarily stored in the machine-readable storage medium such as the memory of a manufacturer's server, an application store's server, or a relay server or may be generated temporarily. Although an embodiment of the inventive concept are described with reference to the accompanying drawings, it will be understood by those skilled in the art to which the inventive concept pertains that the inventive concept may be carried out in other detailed forms without changing the scope and spirit or the essential features of the inventive concept. Therefore, the embodiments described above are provided by way of example in all aspects, and should be construed not to be restrictive.

According to the embodiments disclosed in the inventive concept, damages to Internet users due to pharming may be fundamentally prevented by detecting and blocking malicious DNS servers.

While the inventive concept has been described with reference to embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A malicious domain name system (DNS) server detecting method performed by a server detection device, the method comprising:
transmitting at least one domain address thus pre-verified to at least one DNS server candidate;
receiving at least one IP address associated with the transmitted at least one domain address from the at least one DNS server candidate;
determining at least one verification target DNS server based on the received at least one IP address; and
determining a malicious DNS server among the at least one verification target DNS server by comparing at least one normal IP address with the received at least one IP address.

2. The method of claim 1, wherein the at least one DNS server candidate is selected periodically by using a port scan, and
wherein a use service port is at least one of user datagram protocol (UDP) 53 and transmission control protocol (TCP) 53.

3. The method of claim 1, wherein the determining of the at least one verification target DNS server includes:
determining only a DNS server candidate, which receives an IP address, among the at least one DNS server candidate as the verification target DNS server.

4. The method of claim 1, wherein the determining of the malicious DNS server includes:
determining at least one DNS server, which is associated with at least one IP address that is not the same as the at least one normal IP address, from among the received at least one IP address as the malicious DNS server.

5. The method of claim 4, wherein the at least one normal IP address is periodically obtained from at least one DNS server thus pre-verified by transmitting the pre-verified at least one domain address to the pre-verified at least one DNS server.

6. A malicious DNS server detection device comprising:
a communication unit;
a memory; and
a processor configured to:
allow the communication unit to transmit at least one domain address thus pre-verified to at least one DNS server candidate;
allow the memory to store at least one normal IP address;
receive at least one IP address associated with the transmitted at least one domain address from the at least one DNS server candidate through the communication unit;
determine at least one verification target DNS server based on the received at least one IP address; and
determine a malicious DNS server among the at least one verification target DNS server by comparing at least one normal IP address with the received at least one IP address.

7. The malicious DNS server detection device of claim 6, wherein the at least one DNS server candidate is selected periodically by using a port scan, and
wherein a use service port is at least one of UDP 53 and TCP 53.

8. The malicious DNS server detection device of claim 6, wherein the processor determines only a DNS server candidate, which receives an IP address, among the at least one DNS server candidate as the verification target DNS server.

9. The malicious DNS server detection device of claim 6, wherein the processor determines at least one DNS server, which is associated with at least one IP address that is not the same as the at least one normal IP address, from among the received at least one IP address as the malicious DNS server, and
wherein the at least one normal IP address is periodically obtained from at least one DNS server thus pre-verified by transmitting the pre-verified at least one domain address to the pre-verified at least one DNS server.

10. A computer-readable recording medium storing a program for implementing the malicious DNS server detecting method of claim 1.
